(19) United States
(12) Patent Application Publication
(10) Pub. No.: US 2005/0228101 A1
(43) Pub. Date: Oct. 13, 2005

(54) Cross-linkable and/or cross-linked nanofiller compositions

(76) Inventors: William James McMahon, Victoria (AU); Hans Anton Mayer, Victoria (AT)

Correspondence Address: BROOKS KUSHMAN P.C., 1000 TOWN CENTER, TWENTY-SECOND FLOOR, SOUTHFIELD, MI, 48075, US

(21) Appl. No.: 10/509,505

(22) PCT Filed: Mar. 28, 2003
(86) PCT No.: PCT/AU03/00385

§ 371 Date: Sep. 28, 2004

(30) Foreign Application Priority Data
Mar. 28, 2002 (AU) PS 1464

(51) Int. Cl. C08K 3/34

(52) U.S. Cl. 524/442; 524/445; 524/451

(57) ABSTRACT

The present invention relates to a cross-linkable and/or cross-linked nanofiller composition which comprises a cross-linkable and/or cross-linked ethylene (co)polymer and an intercalated nanofiller. The present invention also relates to processes for preparing the nanofiller composition, articles composed of the nanofiller composition and processes for preparing the articles.

### FIELD OF THE INVENTION

The present invention relates to cross-linkable and/or cross-linked nanofiller compositions, processes for their preparation and articles composed of them, in particular cross-linkable and/or cross-linked nanofiller compositions containing cross-linkable and/or cross-linked ethylene (co)polymers such as polyethylene. These nanofiller compositions possess advantageous properties, more specifically, increased barrier properties, strength and higher heat distortion temperatures which makes them useful in various applications including medical, automotive, electrical, construction and food applications.

### BACKGROUND OF THE INVENTION

Thermoplastic polymers such as thermoplastic polypropylene have been mixed with fillers such as clays or calcium carbonate to produce compositions which only show minimal improvement in mechanical and chemical properties with deterioration during processing.

When nanofillers were added to thermoplastic polymers such as polypropylene in reduced amounts compared to standard fillers, some improvements in properties were obtained such as increased mechanical properties including stress crack resistance and tensile strength, reduction in gas or liquid permeability and increases in crystalline melting temperatures and flame retardancy e.g. reduced dripping in a flame. However, despite the addition of nanofillers, thermoplastic polymers such as polypropylene are still thermoplastic and their thermomechanical properties, tensile strength, resistance to permeability of gases or liquids, resistance to swelling and solvents and flame retardance at higher temperatures including in heat and sunshine is still reduced or limited. This is even more the case with polyethylene which has much lower crystalline melting temperatures than polypropylene. Polyethylene is not traditionally treated in this way because of difficulties in achieving even limited improvements in the above mentioned properties and in general these problems are considered as not being solved with polyethylenes or ethylene copolymers.

The Stress Crack Resistance (SCR) and Environmental Stress Crack Resistance (ESCR) of most thermoplastics at greater than ambient temperatures such as in cars and cables can still be weakened, insufficient and can fail both in prolonged tests and use, in particular in the presence of chemicals, detergents, solvents, liquid fuels and oils.

The swellability and solubility of polyolefin thermoplastics e.g. ethylene polymers in certain solvents, fuels, oils, chemicals strongly increases at elevated temperatures up to unacceptable limits and they may dissolve at elevated temperatures or when boiled or extracted in solvents at higher temperatures. Swellability means deterioration in properties, softening, increase in dimensions, mechanical weakening to the point of structural failure of the product made therefrom and ultimately, in some cases to dissolution of the product.

The flame retardance e.g. of a thermoplastic polymer that has already flame retardant additives, in case of a test or in a real fire, can be reduced or impaired by the dripping thermoplastic polymer in particular in the flame temperature ranges. Dripping can result in acceleration of the fire due to hot, molten, even burning drops of polymer falling on other parts of products under or in the vicinity of the burning polymer.

Thus, the improvements observed by the addition of nanofillers to thermoplastic polymers were not and are not sufficient to reach the higher levels of performance required for increased safety levels of the products made therefrom both mechanically and thermo-mechanically, in particular at higher temperatures or in other difficult conditions such as exposure to chemicals, solvents, oils, fuels or short circuits. These properties are very important for products such as fuel tanks for automobiles, containers for solvents, chemicals, cables, aerial cables, power cables, foils and films. Furthermore, such compositions cannot be used to make heat shrinkable products for joints, sleeves, tubes, pipes, films and packaging.

A requirement accordingly exists for a nanofiller composition or nanocomposite containing thermoplastic polymers which has improved properties so that the products made from these compositions perform well, particularly at temperatures above ambient and/or in difficult environments such as exposure to chemicals, solvents, oils, fuels or short circuits.

### SUMMARY OF THE INVENTION

The present invention provides a cross-linkable and/or cross-linked nanofiller composition which comprises a cross-linkable and/or cross-linked ethylene (co)polymer and an intercalated nanofiller.

Preferably, the composition further comprises an organic silane grafted to the ethylene (co)polymer and/or intercalated into the nanofiller.

The present invention also provides a process for preparing a cross-linkable and/or cross-linked nanofiller composition which comprises either:
(a) mixing and exfoliating and/or delaminating in one step a cross-linkable ethylene (co)polymer and an intercalated nanofiller;
(b) mixing a cross-linkable ethylene (co)polymer with an intercalated nanofiller; and
delaminating and/or exfoliating at least part of the nanofiller; or
(c) delaminating and/or exfoliating at least part of an intercalated nanofiller; and
mixing the delaminated and/or exfoliated intercalated nanofiller with a cross-linkable ethylene (co) polymer.

In another aspect of the process, the ethylene (co)polymer and/or nanofiller are subjected to grafting either before, during or after the mixing and delaminating and/or exfoliating step(s). The grafting preferably involves treating the ethylene (co)polymer and/or nanofiller with an organic silane which is then grafted onto the (co)polymer and/or intercalated into the nanofiller using a free radical initiator.

The present invention further provides an article which is wholly or partly composed of the nanofiller composition defined above.

In a further aspect, the present invention provides a process for preparing the article defined above which comprises either:
(a) forming or shaping the nanofiller composition defined above;
(b) combining at least one layer of the nanofiller composition with at least one other layer;
(c) cross-linking the nanofiller composition defined above; or
(d) heating and stretching the nanofiller composition defined above and cooling the stretched composition.

### DETAILED DESCRIPTION OF THE INVENTION

Suitable ethylene (co)polymers include polyethylene and ethylene based alkene or alphaolefin copolymers, for example, high density polyethylene (HDPE), medium density polyethylene (MDPE), linear low density polyethylene (LLDPE), low density polyethylene (LDPE), very low density polyethylene (VLDPE), and ultra low density polyethylene (ULDPE); ethylene hexene copolymers and ethylene octene copolymers; butylene (co)polymers such as polybutylene and polyisobutylene; ethylene-propylene copolymers (EPM); ethylene-propylene-diene terpolymers (EPDM); ethylene-butylene copolymers (EBM) and terpolymers (EBDM); ethylene-vinylsilane (co)polymers; copolymers or terpolymers of ethylene with acrylic acid (EA) or ethylene with ethylene acrylate and acrylic acid (EAA) or methacrylic acid (EMA); and copolymers of ethylene with ethylacrylate (EEA), butyl-acrylate (EBA) or vinyl acetate (EVA). It will be appreciated that these ethylene (co)polymers may also be in the form of metallocene catalyst (co)polymers.

The ethylene (co)polymers or part of the ethylene (co)polymers may be grafted with compounds containing carboxylic acid or anhydride groups such as maleic anhydride or acid or fumaric anhydride or acid which may facilitate the exfoliation and/or delamination of the nanofiller. Examples of grafted ethylene (co)polymers suitable for use in the present invention include maleic anhydride (MAH) or maleic acid grafted copolymers such as LDPE-MAH, HDPE-MAH, EP-MAH, EPR-MAH, PE-MAH or PP-MAH.

In a preferred embodiment, the ethylene (co)polymer contains or has added, for example, by grafting, polar groups, such as carboxylic groups, for example, EEA or EA, maleic groups or ester groups, for example, EVA, EEA or EBA.

The amount of (co)polymer with polar groups should preferably be at least about 0.01% of the total (co)polymer, more preferably at least about 0.5%, most preferably at least about 5% and even more preferably at least about 8%. In the case of premix masterbatches/concentrates of nanofiller with (co)polymer(s) the amount of (co)polymer with polar groups is preferably at least about 10%, more preferably at least about 15%, most preferably at least about 25% of the (co)polymer in the masterbatch/concentrate.

The ethylene content of the ethylene-propylene copolymers is preferably about 10 to about 99.9% by weight, more preferably about 40 to about 99.9% by weight, most preferably about 75 to about 99.9% by weight. Unless stated otherwise, it will be understood that the term “% by weight” as used herein is based on the total weight of (co) polymer.

The vinyl acetate content of the ethylene-vinyl acetate copolymer (EVA) is preferably about 3 to about 80% by weight, more preferably about 9 to about 70% by weight. The vinyl acetate content is preferably about 9 to about 30% by weight for plastomeric EVA and about 38 to about 50% by weight for elastomeric EVA.

The ethylene (co)polymer may be an elastomer or a plastomer. Plastomers and elastomers can be characterised by means of specific gravity (S.G.) or density, for example, in the case of ethylene-alpha-olefin copolymers and other properties such as the differential scanning calorimetry (DSC) melting peak, Shore A hardness and elasticity modulus. Such properties will vary depending on the type of ethylene (co)polymer and its method of manufacture and the amount of (co)monomer present. By way of example, EVA with up to about 28% VA is considered a plastomer and with above about 38% being considered an elastomer. However, generally plastomers are plastomeric and elastomers are elastomeric or thermoplastic elastomeric and flexible.

Preferably, for plastomeric cross-linkable compositions, at least about 40% to about 50% by weight, more preferably at least about 60% by weight is a plastomer with the balance being an elastomer. Examples of plastomers include polyethylene such as HDPE, MDPE, LDPE, LLDPE or VLDPE; EVA with up to about 30% vinyl acetate; EPM with up to about 25% propylene; and ethylene octene copolymers with a S.G. of at least about 0.887. The elastomers include ethylene octene copolymers with a S.G. of up to about 0.886; an ethylene hexene copolymer; ULDPE; ethylene propylene copolymers such as terpolymers with propylene comonomers of greater than about 30%; ethylene vinyl acetate copolymers with greater than about 38% vinyl acetate; EPDM; EPM; and EPR. Preferably, for plastic-elastomeric or elastomeric cross-linkable compositions, the elastomeric component will be at least about 40%, preferably about 50%, more preferably at least about 60% by weight of the total composition. The most preferred embodiment of this invention is a thermoplastic cross-linkable composition with at least about 40% plastomeric compound by weight of the total composition.

The term “cross-linkable and/or cross-linked” is used herein in its broadest sense and refers to the ethylene (co)polymer and/or a composition based on it being cross-linked or at least capable of being cross-linked at a later stage or of being made cross-linkable. It will be understood that at least one ethylene (co)polymer in the composition may be cross-linkable and/or cross-linked and such a (co)polymer preferably forms at least about 30%, more preferably about 50%, most preferably at least about 70% by weight of the total (co)polymer component.

The term “nanofiller” is used herein in its broadest sense and refers to fillers having a particle size in the nanometre (nm) range, in the order of size of less than about 500 nm. The thickness of the particles is approximately in the order of about 1 nm to about 100 nm and the diameter or length or width can be up to about 500 nm. The ratio between thickness and length or width of the particles is called “aspect ratio” and it is preferred to have or to achieve a high aspect ratio. The particles have a platelet like structure. A nanofiller is capable of being separated by intercalation, delamination and or exfoliation into smaller size groups or layers of less than 100 nanometres thickness, into particles or layers with 1 to no more 5 platelets, preferably into a high proportion of single platelets. When the nanofillers are exfoliated, the thickness of their platelets is reduced to about 1 to about 3 nm. The nanofiller may be present in an amount of about 15 to about 40%, preferably about 15 to about 30% of the masterbatch/concentrate.

The term “intercalated” or “intercalation” is used herein in its broadest sense and refers to a platelet-like or layered structure. The layers of the nanofiller which are generally composed of silicate are treated chemically by removing some cations from between the layers and intercalated with ionic or polar substances including quaternary ammonium salts, such as, optionally substituted long chain hydrocarbon quaternary ammonium salts, for example, benzyl or alkyl substituted long chain hydrocarbon quaternary ammonium salts, alkyl substituted tallow or hydrogenated tallow quaternary ammonium salts; or bis-hydroxyethyl quaternary ammonium salts. Suitable counter anions for the quaternary ammonium cations include halides such as chloride or methyl sulphate.

The intercalated nanofiller may be an intercalated mineral nanofiller or clay which is either synthetic or natural such as, montmorillonite, bentonite, smectite and phyllosilicate which can be or have been intercalated by organic modification with an organic intercalatent selected from the ionic or polar compounds described above and may be sold under the trade names Cloisite (Southern Clay Products), Nanofil (Sudchemie), Tixogel(Sudchemie) and Kunipia.

The organic intercalant may be present in an amount up to about 40% by weight of the nanofiller. The weights in the description and examples refer to the nanofiller as supplied including the organic intercalant.

It should be noted that in some instances the word “intercalation” includes the situation when intended to refer to nanofillers which have been intercalated with the organic intercalant and the distance between their platelets is increased by a few nanometres are then mixed with (co)polymer(s) and the (co)polymer molecules enter between the nano platelet layers thus further intercalating them so that they are delaminated in the mixing process. This type of further intercalation is herein referred to as “delamination” and/or “further intercalation”/delamination/exfoliation. The step of delamination and exfoliation is very important. The effects of this step can be seen in the changes and improvements in the mechanical and thermo-mechanical and chemical and optical and X-ray diffraction properties of the compositions.

Nanofillers such as montmorillonite have an anisotropic, plate like, high aspect-ratio morphology which leads to a long and tortuous diffusion path through the structure of the composition and an improved barrier to permeation, particularly when used in combination with the cross-linked ethylene (co)polymers of the present invention.

The amount of nanofiller is about 0.1 to about 15%, preferably about 1 to about 10%, more preferably about 2 to about 6% by weight.

It will be appreciated that known fillers may optionally and/or additionally be included in the composition. Suitable known fillers include inorganic and/or mineral fillers such as clays which may be calcined; talc; mica; kaolin; alkaline earth metal carbonates, for example, calcium carbonate, magnesium calcium carbonate or hydrated basic magnesium carbonate; and metal hydroxides, for example, aluminum or magnesium hydroxide. The fillers may optionally be coated with, for example, stearic acid, stearates such as calcium stearate, silanes such as vinyl silane, siloxanes and/or organo-titanates. While such coatings can be used to coat the fillers, they can also be added simultaneously, sequentially and/or separately with the fillers.

The composition of the present invention may be subjected to (i) silane grafting; (ii) the addition of cross-linking agents; and/or (iii) radiation cross-linking at any step of the process.

(i) The silane grafting may be performed using an organic silane and a free radical initiator. In an embodiment preferred for economical reasons, effective amounts of organic silane and peroxide are added to the (co)polymer and/or nanofiller either before or during the mixing step and then grafted onto the (co)polymer at temperatures preferably of about 160 to about 240° C., more preferably about 180 to about 230° C., most preferably about 190 to about 220° C. This grafting is carried out either in the first mixing step or in a subsequent or even in a separate mixing step, after the (co)polymer and nanofiller have been mixed. In a particularly preferred embodiment, the silane and the peroxide are added to both the (co)polymer and/or nanofiller which facilitates exfoliation and/or delamination of the nanofiller and grafting to the polymer in one step. In an alternative embodiment, the (co)polymer is grafted using the organic silane and peroxide and then mixed with the nanofiller followed by exfoliation and/or delamination.

In another embodiment, the (co)polymer(s), of which at least one has polar group(s), is or are mixed with the nanofiller for the purpose of polymer intercalation and/or delamination or exfoliation at temperatures up to about 200° C. The resulting intercalated polymer is then mixed in a second step with further (co)polymer, a free radical initiator peroxide and an organic silane and grafted onto the (co)polymer(s) at higher temperatures, preferably about 190 to about 220° C. The masterbatch of nanofiller in a (co)polymer(s) can be made with about 15 to about 45% nanofiller content. It is then subsequently mixed in a second step with further (co)polymer(s) and then grafted with peroxide and vinyl silane in the same second step or in a third step.

Suitable organic silanes include vinyl silanes, for example, vinyl alkoxy silane such as vinyl-tris-methoxy-silane (VTMOS), vinyl-tris-methoxy-ethoxy-silane (VTMOEOS), vinyl-tris-ethoxy-silane, vinyl-methyl-dimethoxy-silane and gamma-methacryl-oxypropyl-tris-methoxy-silane; or long aliphatic hydrocarbon chain silanes.

Vinyl silanes are preferred and may be added in an amount from about 0.5 to about 2.2% by weight of the (co)polymer, preferably about 0.8 to about 2%, more preferably about 1 to about 1.8% by weight.

The term “free radical initiator” is used herein in its broadest sense and refers to an unstable molecule or compound which generates free radicals. Examples of suitable initiators include peroxides such as dicumyl peroxide, di-tertiary-butyl peroxide, tertiary-butyl-cumyl peroxide and bis-tertiary-butyl-cumyl peroxide i.e., di(tert-butyl-peroxy-diisopropyl benzene) and 2,5-dimethyl-2,5-di(tert-butylperoxy)hexane. The free radical initiator is preferably added in an amount of about 0.05 to about 0.3% by weight calculated on the amount of (co)polymer, more preferably about 0.15 to about 0.2% by weight. The (co)polymer and/or composition may also be cross-linked after grafting the (co)polymer or composition with an organic silane with the aid of a free radical initiator. Catalysts for cross-linking include DBTDL (di-butyl-tin-dilaurate) or dioctyl-tin-dilaurate (DOTDL) or other known catalysts. For this type of subsequent cross-linking the presence of moisture, water or steam is required, preferably with a catalyst added. A wider, more flexible range of ratios of peroxide to vinylsilane to be grafted is possible. The peroxide addition is possible up to about 0.5%.

Silane cross-linking is also called moisture cross-linking. After forming the article made by extrusion and/or moulding, film forming is carried out in the presence of water, steam or moisture at ambient or preferably at higher temperatures of up to about 90° C. to about 100° C. or higher if pressure is applied. Catalyst e.g. di-butyl-tin dilaurate (DBTDL), di-octyl-tin dilaurate (DOTDL), is added to the cross-linkable composition prior to or during forming, or it can be added to the water used for cross-linking in it as a medium.

The speed and the duration of the cross-linking will depend on the type of (co)polymer and nanofiller used in the composition, of the temperature, of the humidity or water present and of the thickness of the composition.

(ii) The (co)polymers, compositions and/or articles of the present invention may be cross-linked by adding cross-linking agents such as organic peroxides, for example, dicumylperoxide, di-tert-butyl peroxide, and/or di-tert-butyl cumyl peroxide preferably in amounts of about 1.4 to about 2.2% by weight. These agents are added to the (co)polymer and nanofiller either by absorption at temperatures where they are or become liquid (e.g. at about 60° C.), or in a subsequent melting process in a mixer keeping the temperature of the melt below the decomposition temperature of the peroxide(s) i.e., below about 120° C. Silanes are not required in this process for grafting, however they may be added or have been added separately to the filler(s) or added in the mixing process prior to or during the mixing of the peroxide to the (co)polymer and nanofiller mix preferably keeping below about 120° C. Co-agents such as polyallylcyanurates (TAC and Sartomer 350) may also be added prior to or during the mixing of the peroxide(s).

The composition can be cross-linked at temperatures above the decomposition temperature of the peroxide(s) in the absence of oxygen. The cross-linking of the peroxide cross-linkable composition or the resulting products may be conducted after forming of the article by extrusion and/or moulding, in steam or nitrogen or liquids such as molten salt mixtures, for example, potassium nitrate-nitrite mixtures under pressure at elevated temperatures, higher than the decomposition temperatures of the peroxides used to form free radicals at about 150 to about 220° C.

(iii) The radiation cross-linking may be conducted using gamma-radiation, for example, CO⁶⁰ or high energy electron beam radiation in air or under nitrogen at ambient or above ambient temperatures. Co-agents such as Sartomers, which enhance radiation cross-linking and enable a lower radiation dose to be used, can also be added either during or subsequent to the mixing step preferably in an amount of about 1 to about 3% by weight. Examples of such co-agents include unsaturated allylic compounds, triallylcyanurate, acrylic compounds and acrylate or polyacrylate compounds. Protection against radiation damage to the (co)polymer can also be achieved by the addition preferably of up to about 2% by weight of radiation protectors such as trimethyl quinoline polymers or oligomers, for example, Age Rite Resin D and Anox HB.

Radiation cross-linking may be carried out at room temperatures or rising above ambient due to the high energy radiation.

It will be appreciated that one or more additives known in the art of polymer processing can also be included in the composition and added at any stage of the process. They can be added during the mixing steps or at the stage of forming in the form of masterbatches/concentrates incorporated separately or in the catalyst masterbatch. Suitable additives include antioxidants, for example, phenolic antioxidants such as SANTONOX R marketed by Monsanto and IRGANOX 1010 which is pentaerythritol tetrakis (3-(3,5-di-tertbutyl-4-hydroxyphenyl)propionate or IRGANOX 1035 which is octadecyl-3-(3,5-di-tert-butyl-4-hydroxyphenyl)-propionate, Irganox B900, or process stabilisers such as Irgafos 168 marketed by Ciba-Geigy or aminic antioxidants such as Vulcanox HS and Flectol H which are polymerised 2,2,4-trimethyl-1,2-dihydroquinoline; metal deactivators and/or copper inhibitors, for example, hydrazides such as oxalic acid benzoyl hydrazide (OABH) or Irganox 1024 which is 2,3-bis((3-(3,5-di-tert-butyl-4-hydroxyphenyl)proponyl))propiono hydrazide; UV absorbers, for example Tinuvin or HALS type UV absorbers; foaming or blowing agents which may be either endothermic or exothermic for example, p.p-oxybis benzene-sulfonyl-hydrazide, azo-iso-butyro-nitrile and azodicarbonamide; processing and/or thermal stabilisers, for example tris (2,4-ditert-butylphenyl)phosphite (phosphite based), pentaerythritol tetrakis (3-(3,5-di-tert-butyl-4-hydroxyphenyl)propionate), octadecyl-3-(3,5-di-tert-butyl-4-hydroxyphenyl)propionate, 3,3′,3′,5,5′,5′-hexa-tert-butyl-a,a′,a′-(mesitylene-2,4,6-triyl)tri-p-cresol (phenolic based) and dioctadecyl-3,3′-thiodipropionate (thioester based); pigments, for example, inorganic pigments such as titanium dioxide and carbon black and organic pigments; flame retardants, for example, borates and metaborates such as zinc borate or metaborate, glass beads or particles, silica, silicon dioxide, compounds of silicon dioxide with other metal oxides; extenders, plasticisers or softeners, for example, polymeric plasticisers, phthalates such as dioctylphthalate, dioctylsebacate or dioctyladipate or mineral oils such as naphthenic, paraffinic or aromatic oils.

The (co)polymers are preferably granulated, pelletised, powderised, cut and/or diced. The (co)polymer and the nanofiller can then be premixed or added simultaneously, sequentially and/or separately to any suitable known apparatus, such as roll mills, internal mixers, for example, of the Banbury or Shaw type, single screw mixers of the Buss-Ko-Kneader type or continuous mixers, for example, twin screw mixers such as contra-rotating or co-rotating or co-rotating twin screw mixers i.e., Werner Pfleiderer ZSK. It will also be understood that the known fillers and/or additives can be added simultaneously, sequentially and/or separately at any stage of the processing.

The nanofiller or composition may be intercalated with (co)polymer(s), delaminated and/or exfoliated using any suitable known technique such as high shear processing, for example, in the mixing apparatus referred to above. In variations of process steps (a) to (c) defined above, a further exfoliation and/or delamination step may be performed using the mixing apparatus described above.

Similar mixing apparatus may be used for silane grafting (i) described above.

For mixing, delaminating, exfoliating and/or silane grafting, these mixing apparatus may be equipped with nitrogen blanket applicators, pre-dryers, either pre-mixing and/or dosage equipment/pumps for the silane and peroxide mix, side-feeders, vacuum ports, several entry ports, granulation, pelletising and/or dicing equipment.

Mixing is preferably performed in one step, for economical reasons. It can also be done in two separate steps.

In one embodiment, the first step involves mixing and intercalation/delamination/exfoliation preferably at temperatures at up to about 200° C. and then separately grafting the silane with peroxide in a second step at temperatures of above about 200° C., but preferably not higher than about 220° C.

In another embodiment, the (co)polymer(s) are grafted in a first step at about 200° C. to about 240° C. and then in a second step after cooling, adding the nanofiller either as a masterbatch/concentrate which has been intercalated with polymer and delaminated/exfoliated and mixing at temperatures of up to about 200° C., or adding the nanofiller(s) to the grafted (co)polymer and intercalating with polymer/delaminating/exfoliating the nanofiller at temperatures of up to about 2002C.

In a further variation of the process of the invention, the (co)polymer, nanofiller and/or other additives are advantageously dry or dried in a separate step prior to processing involving hot air or dessicated hot air, in particular when silane grafting is used.

The composition of the invention can be formed by any suitable known process including moulding, such as injection moulding, blow moulding or compression moulding; pressing; vacuum forming; extrusion such as co extrusion, tandem extrusion or lamination with other layers for example polymeric layers; calendering and heat shrinking. The heat shrinking process involves cross-linking the article of the composition and heating and stretching the composition and then cooling the composition in its stretched state. When the heat shrinkable articles are reheated to temperatures above the crystalline melting point, they display shape memory properties, that is, they retain or regain or shrink to their original shape and size.

The composition of the present invention is either cross-linkable in the form of granules, premixes or mixes, pellets, tapes or profile or intermediary, semi-fabricated articles or cross-linked in the form of intermediary, semi-fabricated or final articles. Examples of articles include profiles, tubes, pipes, films, sheet, tiles, floor coverings, containers and packaging for food.

The compositions of the present invention possess advantageous properties including high modulus and strength, increased barrier properties such as reduced penetration, permeation and/or lower diffusion of chemical solvents, oils and gases, reduced swelling, high heat distortion temperatures, increased dimensional stability, no melting, improved flame retardancy, lower specific gravity/density. These properties exist and their improvements are more evident in particular at high temperatures or in adverse environmental conditions.

Examples of applications of the composition include:

Medical: protective gear and clothing, medicine containers, layered products;

Defence applications and work protection: protection against external chemicals, substances;

Transport: land, vehicles, trains, subways, sea, ships, air, transport of liquids or gases such as pipelines, pipes for hot water under pressure and gas;

Construction: high rise, towers, installations and rooms with electronics, switches, computers, offices, public areas, theatres, cinemas, malls, stations, airports, telecom installations, storage, pipes and tubes;

Agriculture;

Food: packaging of consumables, protecting food in laminated films; and

Packaging: of chemicals, paints, liquids, solutions, dispersions, aqueous or solvent based.

### EXAMPLES

The invention will now be described with reference to the following non-limiting examples.

The compositions of the examples were prepared using various continuous co-rotating twin-screw mixers of ZSK type from Werner & Pfleiderer ZSK and/or Toshiba TEM, of different sizes and build. The compositions of Comparative Examples 1 and 2 and Examples 1 to 3 were prepared on a ZSK53 line A with the co-rotating screws of 53 mm diameter each with screw speeds of around about 200 rpm and feeding of about 50 kg/hour. The compositions of Examples 4 to 6 were prepared on a ZSK120 with co-rotating screws of 123 mm diameter with down stream feeders (lineD), using a range of around 150 to 180 rpm and a feeding rate of up to about 400 kg/hour.

The compositions of Examples 9 to 24 were mixed on a ZSK (line A) with 53 mm screw diameters (same as for Examples 1 to 3), unless indicated otherwise, namely: Examples 7 to 9, 12 to 22 were made on line A. The screw speeds were however in the range of 180 to 200 and in some examples even to 250 rpm as it was found that exfoliation was improved at higher speeds.

The compositions of Examples 11 and 12, (similar to Examples 4 to 6) were prepared on a TEM 120 mm line with screw diameters of 123 mm with down stream feeders. Various screw speeds and temperature ranges were used, adequate to the task and (co)polymer(s) and type of peroxide-silane mixes used in case of grafting or a grafting step. The screw speeds were varied and used up to 250 rpm such as in Example 15.

The temperature was in the general range of 180-220° C. for LLDPE and 190-240° C. for HDPE.

The temperatures were in a number of Examples kept below about 200° C. on the extruder zones and 210° C. melt temperature at the exit to minimise degradation effects on the and to protect the intercalating agent in the nanofiller; in case of grafting the temperatures were at or around 190° C. preferably 200 to 210° C. in the extruder zones and 210° C. to about 220° C. or more at the exit melt temperatures or higher, in particular when the grafting was performed in a second step.

In Comparative Examples 1 and 2 and Examples 1, 2, 5 and 7, the components were mixed and grafted in the first step and either no nanofiller was added or nanofiller was added in the same step (Examples 1 and 2), or later (Example 8). Examples 8 and 9 were made using compositions premixed with nanofillers from Examples 7 and 4 and other PE additives followed by grafting with peroxide and silane in a second step.

In Examples 12, 13 and 14, the components were mixed, grafted and further intercalated with polymer and/or exfoliated in one step, with the addition of some components.

In Examples 3, 4, 6, 10, 11, 15A, 15B, 17, 19A, 20A and 21 the components were mixed with nanofillers and the (co)polymer(s) processing them for further intercalation (with the polymer and/or co-polymer) and for exfoliation in a first step and these compositions were then available for use as such or mixed with additional (co)polymer(s) and with vinylsilane and peroxide for grafting in a second step.

Examples 16, 18, 19B and 22 were prepared using compositions from Examples 15A, 17, 19A and 20 respectively which were prepared in a separate first step in which the nanofiller was added and further intercalated/exfoliated and then in the second step, grafting with vinylsilane and peroxide and further exfoliation was performed.

Example 21 was also made in a second step using the masterbatch composition from example 20 added to additional PE polymers with further exfoliation. Example 21 can be used as such and is cross-linkable when grafted with peroxide and siloxane in the same second step or in a separate third step.

Some of the additives and nanofillers were added as pre-mixed or as a master-batch or concentrate. This was also the case in the examples where the compositions from previous examples were used in a second step.

In some of the examples, the nanofiller was mixed with a polar (co)polymer(s) and intercalated/exfoliated in a first step forming a pre-mix or masterbatch or concentrate and then mixed with more or added (co)polymer(s) with silane grafting and further intercalation/exfoliation in a second step.

A nitrogen blanket was used in each example (i.e. the feeding zone or zones were under nitrogen atmosphere for safety reasons and also for more efficient use of the peroxide radical initiator).

The processing was done as far as possible under dry conditions.

The compositions were granulated or pelletised directly at the exit of the ZSK mixers. Packaging was in metal lined bags of various size.

The silane grafted material was mixed with 4% of a catalyst masterbatch of e.g. DLDTP which is an accelerator catalyst directly prior to the formation of a product e.g. extrusion forming to tapes or to injection moulding for test plaques or prior to extrusion or extrusion of larger items or blow forming. These were then cross-linked in hot water, at temperatures of 90 to 110° C. for 1 to 2 up to 4 hours, depending of the thickness of the sample.

The testing was performed to Australian Standards (AS) which are in general harmonised with International Standards such as IEC, BS, DIN/VDE, EN (European Norms) and to ASTM test methods.

Mechanical properties were tested to above standards.

Oil resistance (O.R.) was tested to ASTM using ASTM oil nr.2, a criterion is the retention of 70% of original properties.

Environmental stress crack resistance (ESCR) was also tested to ASTM (AS)in tensioactive liquid at 50° C., with unnotched samples. In general, results of over 100 hours are aimed to be achieved. In the case of nanocomposites and in particular cross-linked nanocomposites, results of thousands of hours e.g. 8000 hours were achieved and are still ongoing.

Hot Set test (HST) was made to AS: non-cross-linked materials, including nanocomposites would fail the test at above their melting temperatures and break away after short time anyway at 200° C. The requirement for cables is a maximum elongation under load of 175%. After 20 minutes and taking the load away the samples must revert to a maximal residual elongation of 15% or 25% for rubber/elastomers.

For some other applications the requirements are not so restricted.

The elongations under load could be higher.

The cross-linked or cross-linkable compositions of the present invention pass the HST.

Gel content was performed in boiling xylene to ASTM. The gel content shows that a composition has some degree of cross-linking. The main test for cross-linking is the HST. The gel content in silane grafted cross-linked materials is less related to the HST.

Impact resistance is tested to ASTM D-256 Izod pendulum impact resistance of notched plastics.

The components used in the examples are from:

Qenos, Melbourne, Australia: for HDPE GM7655, GA7260H, HD1090, HD6025, LLDPE Alkatuff 425;

BASF Ludwigshafen, Germany: for HDPE HMW Lupolen 4261A;

Sabic, LLDPE Ladene MG200024;

DuPont, USA: EVA Elvax 470, Elvax 750, Elvax 760, MAH-HDPE Fusabond MB100D;

Sud-Chemie, Moosburg, Germany: Nanofil 15, Tixogel MP100;

SCP Southern Clay Products, Gonzales, Tex., USA: Cloisite 15A, Cloisite 20A;

Crompton, USA/Switzerland: Silox VS 911, Silox VS924, Peroxide and Silane mix.

Other suppliers of similar materials e.g. Degussa, Germany, etc. CIBA, Switzerland: Antioxidants, Stabilisers: Irgafos FF168, Irganox B900;

Great Lakes Chemicals, USA: Antioxidants: Anox 20.

Compco Pty Ltd, Melbourne, Australia: Compylene Master-batches of Antioxidant: EL900140AO, Processing aid: FL90016PA5.

The proportions of the components used in the compositions of the Examples are given in % by weight of the total composition. These %s have been rounded to the first decimal point.

### Comparative Example 1

| | |
|---|---|
| HDPE Qenos GM7655 MFI 0.2, granules | 83.5% |
| HDPE Qenos GA7260H MFI 25, powder | 14.7% |
| Silox VS 911 Crompton | 1.2% |
| Stabiliser Irganox 168 FF | 0.2% |
| Anox 20 Great Lakes | 0.4% |

Hot Set Test (at 200° C.):

| | |
|---|---|
| Elongation under load | 37% |
| Residual elongation relaxed, no load | 0% |

### Comparative Example 2

| | |
|---|---|
| LLDPE Alkatuff 425 (MFI 2.5) granules | 78.7% |
| LLDPE Ladene MG200024, (MFI 20)powder | 19.7% |
| Silox VS 924 (Vinyl silane and Peroxide) | 1.4% |
| Irganox B 900 | 0.2% |

### Hot Set Test (at 200° C.):

| | |
|---|---|
| with load | 270%* |
| without load | 10% |

*requires more Silox addition to 1.6%

### Example 1

| | |
|---|---|
| LLDPE Alkatuff 425 granules | 73.8% |
| LLDPE Ladene GM200024, powder | 18.4% |
| Silox VS 924 | 1.6% |
| MAH-HDPE Fusabond MB 100D | 1.0% |
| Irganox B 900 | 0.2% |
| Tixogel MP 100 Sudchemie | 5.0% |

Hot Set Test (at 200° C.):

| | |
|---|---|
| under load | 77% |
| without load | 0% |

### Example 2

| | |
|---|---|
| LLDPE Alkatuff 425 granules | 74% |
| LLDPE Ladene powder | 18.5% |
| Silox VS 924 | 1.4% |
| MAH-HDPE Fusabond MB 100 D | 1.0% |
| Antioxidant Irganox B 900 | 0.1% |
| Tixogel MP 100 filler | 5.0% |

Hot Set Test (at 200° C.):

| | |
|---|---|
| under load | 100% |
| without load | 0% |

The addition of Tixogel has significantly improved the cross-linking of the composition compared to Example 2.

### Example 3

| | |
|---|---|
| LLDPE Alkatuff 425 granules | 79.3% |
| LLDPE Ladene powder | 14.0% |
| MAH-HDPE Fusabond MB 100 D | 1.0% |
| Irganox 168 FF | 0.2% |
| Anox 20 | 0.4% |
| Tixogel MP 100 | 5.1% |
| Flexural modulus, Mpa | 557 |
| Tensile Strength (TS), at yield Mpa | 24.2 |
| Tensile strength at break Mpa | 13.2 |
| Impact resistance Izod, Mpa | 273 |

This composition is not grafted nor cross-linked.

### Example 4

| | |
|---|---|
| HDPE HMW Lupolen 4261A powder | 88.1% |
| Stabiliser mix: | |
| Irgafos 168FF + Anox20 + Ca-Stearate (0.2 + 0.2 + 0.5%) | 0.9% |
| MAH-HDPE Fusabond MB 100D | 1.0% |
| Tixogel/Lupolen mix (30% Tixogel:70% Lupolen): | |
| Lupolen 4261A | 7.0% |
| Tixogel MP100 (via side feeder) | 3.0% |
| Flexural modulus, Mpa | 531 |
| TS at yield Mpa | 22.1 |
| TS at break Mpa | 17.3 |
| Elongation at break | 568% |
| Impact resistance Izod, J/m | 156 |

This composition is made in one step and is not grafted nor cross-linked.

### Example 5

| | |
|---|---|
| HDPE GM 7655 granules | 82.0% |
| Lupolen 4261 powder*(pre-mixed with following Silox) | 13.4% |
| Silox VS 911*(pre-mixed with above Lupolen powder) | 1.6% |
| Processing aid Compylene FL900140AO | 1.0% |
| (Masterbatch/concentrate: 5% Fluorocarbon polymer | |
| in 90% LLDPE) | |
| Stabiliser/Antioxidant masterbatch EL900140AO | 2.0% |
| (10% Irganox B900 and 90% LLDPE) | |

The Pre-mix* of Lupolen and Silox was high speed pre-mixed and added via a separate feeder.

Hot Set Test (at 200° C.):

| | |
|---|---|
| Elongation with load | 160% |
| Elongation relaxed (after removing load) | 7% |
| Flexural modulus, Mpa | 558 |
| TS (at yield, Mpa | 23 |
| TS at break, Mpa | 14.8 |
| Impact resistance Izod, J/m | 771 |

### Example 6

### Composition from Example 5 [90%]

| | |
|---|---|
| HDPE GM 7655 granules* | 73.0% |
| HDPE GA 7260H powder* | 11.9% |
| Silox VS 911* | 1.4% |
| Antioxidant* (masterbatch/concentrate) | 1.8% |
| Process aid* (masterbatch/concentrate) | 0.9% |
| MAH-HDPE Fusabond 100 D | 1.0% |
| [Subtotal of grafted composition* ex. 5 | 90% |

Composite mix**(incl. Tixogel filler) [10%]

| | |
|---|---|
| Tixogel MP 100(via side feeder) | 3.0% |
| Irgafos 168FF(process stabiliser) | 0.2% |
| Calcium stearate | 0.5% |
| HDPE, MFI 20, MG 20224 powder | 0.9% |
| HDPE Lupolen 4261A | 2.1% |
| Composition of Example 5 | 3.1% |
| Anox 20 | 0.2% |
| Subtotal of composite mix** | 10.0% |
| Total composition example 6 | 100% |

*These components were pre-mixed and grafted separately.

Hot Set Test (at 200° C.): (above 10% comp. mix** consisting of:

| | |
|---|---|
| elongation under load | 173% |
| elongation with load removed (relaxed) | 7% |

### Example 7

| | |
|---|---|
| HDPE MFI 10, HD1090 granules | 88.3% |
| LLDPE Ladene MG200024 powder | 9.7% |
| Silox VS 911 | 1.6% |
| Irgafos 168 FF (process stabiliser) | 0.2% |
| Anox 20 | 0.2% |

After grafting and just prior to forming, 5% catalyst masterbatch/concentrate was added.

Hot Set Test (at 200° C.):

| | |
|---|---|
| Elongation under load | 250% |
| Residual elongation relaxed | 16% |
| Flexural modulus, Mpa | 552 |
| TS at yield Mpa | 24.2 |
| TS at break Mpa | 15.5 |
| Gel content (BS EN579, after boiling in | 54.7% |
| xylene): | |
| O.R. (Oil Resistance ASTM Oil nr. 2 100° C., 24 hrs): | |
| O.R.TS(yield) retained: | 82.1%; |
| TS(break)retained: | 143% |
| O.R. EB (elongation at break) change: | +133% |
| O.R.: change in dimensions: | +4% |
| Impact resistance Izod, J/m | 686 |
| ESCR (ASTM) F0, hours (environmental stress crack | 8820 |
| resistance, at 50° C. No failure after 8820 hours, ongoing) | |

### Example 8

| | |
|---|---|
| Composition of Example 7 | 86.9% |
| HDPE Ladene GM200024 (MFI 20)powder | 8.7% |
| Tixogel MP100 | 3.0% |
| Stabiliser mix composed of: | |
| Irgatos 168FF (process stabiliser) | 0.2% |
| Anox 20 antioxidant | 0.2% |
| MAH-HDPE Fusabond MB100D | 1.0% |

Hot Set Test (at 200° C.):

| | |
|---|---|
| load | 167% |
| relaxed | 13% |
| TS at yield, Mpa | 25.6 |
| TS at break, Mpa | 16.5 |
| Flexural modulus, Mpa | 655 |
| Gel content (BS EN 579) | 55.8% |
| O.R. (oil resistance ASTM Oil nr. 2, 100° C., 24 hrs): | |
| O.R. TS(yield) retained: 82.5%; TS(@break)ret | 131% |
| O.R. EB(elong. @ break) | +105% |
| change: | |
| O.R. change in dimensions | 3.5% |
| Impact resistance Izod, J/m | 221 |
| ESCR, F0(no failure, ongoing)hrs | 8820 |

### Example 9

| | |
|---|---|
| Composition of Example 4 | 88% |
| HDPE GM5010T2 powder | 10% |
| Antioxidant | 0.4% |
| Silox VS 911 | 1.6% |
| HST (Hot Set Test 200° C., 200 kPa): | 63% |

### Example 10

| | |
|---|---|
| HDPE 1090 | 53% |
| GM 7655 powder | 15% |
| MAH-HDPE Fusabond MB100D | 15% |
| Nanofil 15 (via side feeder) | 15% |
| Antioxidant EL900140(10% Irganox B900, 90% LLDPE) | 2% |
| TS at yield, Mpa | 28.5 |
| TS at break, Mpa | 11.6 |
| Flexural modulus, Mpa | 912 |
| Impact resistance Izod, J/m | 155 |

This composition is not-grafted nor cross-linked. It can be silane grafted and cross-linked or added as a masterbatch to other compositions to have a Nanofil concentration of 5 or 3% and to be grafted and cross-linked.

### Example 11

| | | |
|---|---|---|
| HDPE GF 7655 | | 83% |
| HDPE GM 7655 powder | | 5% |
| MAH-HDPE Fusabond MB100D | | 5% |
| Antioxidant EL900140(10% Irganox B900, | | 2% |
| 90% LLDPE) | | |
| Cloisite 20A* (via side feeder) | | *5% |
| Nanofil 15 (via side feeder) | | 5% |
| TS at yield, Mpa | 26.9* | 29.2 |
| TS at break, Mpa | 11.5 | 11.5 |
| Flexural modulus, Mpa | 757 | 851 |
| Impact resistance Izod, J/,m | 161 | 193 |

This composition may be grafted with vinylsilane and peroxide for subsequent cross-linking. Alternatively, the composition may be cross-linked after peroxide addition or by other cross-linking.

### Example 12

| | |
|---|---|
| EVA Elvax 760 (9.3% VA, MFI2 = 2) | 83.2 |
| LLDPE Ladene MG200024 (20MFI) powder | 10 |
| Nanofil 15 | 5% |
| Silox VS 924 | 1.8% |
| HST: | 50% |

### Example 13

| | |
|---|---|
| MAH-HDPE Fusabond MB100D | 83.2% |
| LLDPE Ladene MG200024 (MFI20) | 10% |
| Nanofil 15 | 5% |
| Silox VS 924 | 1.8% |
| TS at yield, Mpa | 25.2 |
| TS at break, Mpa | 15.0 |
| Flexural modulus, Mpa | 654 |
| O.R. (oil resistance), TS @ break retained: | 99% |
| O.R. EB (elongation @ break) retained | 95% |
| Gel content: | 28.8% |
| Impact resistance Izod, J/m | 103 |

### Example 14

| | |
|---|---|
| MAH-HDPE Fusabond MB100D | 83.2% |
| LLDPE Ladene MG200024 (MFI20) | 10% |
| Nanofil 15 (dried) | 5% |
| Silox VS 924 | 1.8% |
| TS at yield, Mpa | 25.0 |
| TS at break, Mpa | 15.2 |
| Flexural modulus, Mpa | 636 |
| Gel content: | 34% |
| O.R. (100° C., 24 hrs), TS @yield retained: | 80% |
| O.R. 100° C., 24 hrs TS @ break retained: | 95% |
| O.R. (100° C., 24 hrs), EB retained: | 90.5% |
| Impact resistance Izod, J/m | 114 |

### Example 15

| | |
|---|---|
| Elvax 750 EVA (9% VA, MFI2 = 7) | 70% |
| LLDPE Ladene MG200024 (MFI20) | 15% |
| Nanofil 15 | 15% |

This composition is not grafted nor cross-linked.

| Examples: | | |
|---|---|---|
| | Ex. 15A | Ex. 15B |

| | | | | |
|---|---|---|---|---|
| Mixed at rpm: | 200 | rpm | 250 | rpm |
| HDT(° C.) | 36 | | 35 | |
| TS at yield, Mpa | 8.2 | | 8.3 | |
| TS at break, Mpa | 8.4 | | 8.5 | |
| Elongation at break, % | 110 | | 107 | |
| Flexural modulus, Mpa | 222 | | 242 | |

[Note:
increase in flexural modulus with increase in rpm]

### Example 16

| | |
|---|---|
| HDPE Qenos GF 7660 | 54.9% |
| LLDPE GME200024 powder | 10% |
| Composition of Example 15A | 33.3% |
| Silox VS 911 | 1.8% |
| HST (hot set test at 200° C.): | 23% |

### Example 17

| | |
|---|---|
| EVA Elvax 470(18% VA, MFI2 = 0.7) | 70% |
| LLDPE Ladene MG200024 (20MFI) powder | 15% |
| Nanofil 15 | 15% |

This composition is not grafted nor cross-linked.

| | |
|---|---|
| HDT: ° C. | 41 |
| TS at yield, Mpa | 7.9 |
| TS at break, Mpa | 12.6 |
| Elongation at break, % | 420 |
| Flexural modulus, Mpa | 851 |

### Example 18

| | |
|---|---|
| HDPE GF 7660 | 54.9% |
| LLDPE GM200024 powder | 10% |
| Composition of Example 17 | 33.3% |
| Silox VS 911 | 1.8% |
| TS at yield, Mpa | 24.7 |
| TS at break, Mpa | 22.0 |
| HST (at 200° C., 200 kPa): | 20% |
| Gel content (BS EN 579, boiling xylene): | 67.1% |
| O.R.: TS @ break retained: | 95% |
| O.R. EB retained: | 115% |
| Impact resistance Izod, J/m | 560 |

### Example 19

Example 19A

| | |
|---|---|
| MAH-HDPE Fusabond MB100D | 70% |
| LLDPE Ladene MG200024 (MFI 20) | 15% |
| Tixogel MP100 | 15% |

The components were mixed in one step. This composition is not grafted nor cross-linked.

### Example 19B

| | |
|---|---|
| HDPE Qenos GF 7660 | 54.9% |
| LLDPE Ladene GM200024 powder | 10% |
| Composition of Example 19A | 33.3% |
| Silox VS 911 | 1.8% |
| TS at yield, Mpa | 30.7 |
| TS at break, Mpa | 26.0 |
| Flexural modulus, Mpa | 744 |
| HST: (excellent) | 27% |
| Gel content | 55.3% |
| O.R. TS @break retained: | 104% |
| O.R. EB (elong. at break) retained: | 154% |
| O.R. change. +54% | |
| O.R. change in dimensions: 3% resp. 5% | |

### Example 20

| | |
|---|---|
| MAH-HDPE Fusabond MB100D | 70% |
| LLDPE Ladene MG200024 (MFI = 20) | 15% |
| Nanofil 15 | 15% |

This composition is not grafted nor cross-linked.

### Example 21

| | |
|---|---|
| HDPE GF7660 | 56.7% |
| LLDPE GM200024 powder | 10% |
| Composition of Example 20 | 33.3% |

This composition is not grafted nor cross-linked. The Nanofil 15 content after the composition from Example 20 is mixed with the other components is 5%.

| | |
|---|---|
| Flexural modulus, Mpa | 839 |
| TS at yield, Mpa | 27.7 |
| TS at break, Mpa | 12.4 |
| Impact resistance Izod, J/m | 100 |

### Example 22

| | |
|---|---|
| HDPE GF 7660 | 54.9% |
| LLDPE GM200024 powder | 10% |
| Composition of Example 20 | 33.3% |
| Silox VS 911 | 1.8% |
| HST: | 40% |

### Example 23

| | |
|---|---|
| EVA Elvax 750 (VA 9%, MFI2 = 7) | 66.7% |
| Composition of Example 15A, granules | 33.3% |
| (mixed granules, by injection moulding) | |
| TS at break, Mpa | 8.2 |
| Elongation at break, % | 140 |

This composition is not grafted nor cross-linked.

### Example 24

| | |
|---|---|
| EVA Elvax 470 (VA 18%, MFI2 = 0.7%) | 66.7% |
| Composition of Example 17 | 33.3% |
| (mixed granules, by injection moulding) | |
| TS at break, Mpa | 10.9 |
| Elongation at break, % | 359 |

This composition is not grafted nor cross-linked.

| | |
|---|---|
| HDPE 1090 | 83% |
| HDPE GM 7655 powder | 5% |
| MAH-HDPE Fusabond MB100D | 5% |
| Nanofil 15 | 5% |
| Antioxidant EL-900140 | 2% |
| TS at yield, Mpa | 29.2 |
| TS at break, Mpa (inj. moulded dumbells) | 11.2 |

Many modifications may be made to the preferred embodiment as described above without departing from the spirit and scope of the present invention.

1. A cross-linkable and/or cross-linked nanofiller composition which comprises a cross-linkable and/or cross-linked ethylene (co)polymer and an intercalated nanofiller.

2. A composition according to claim 1, in which the ethylene (co)polymer is selected from polyethylene and ethylene based alkene or alphaolefin copolymers.

3. A composition according to claim 1, in which the ethylene (co)polymer is high density polyethylene (HDPE), medium density polyethylene (MDPE), linear low density polyethylene (LLDPE), low density polyethylene (LDPE), very low density polyethylene (VLDPE), ultra low density polyethylene (ULDPE), an ethylene hexene copolymer, an ethylene octene copolymer, a butylene (co)polymer, an ethylene-propylene copolymer (EPM), an ethylene-propylene-diene terpolymer (EPDM), an ethylene-butylene copolymer (EBM) or terpolymer (EBDM), an ethylene-vinylsilane (co)polymer, a copolymer or terpolymer of ethylene with acrylic acid (EA) or ethylene with ethylene acrylate and acrylic acid (EAA) or methacrylic acid (EMA) and/or a copolymer of ethylene with ethylacrylate (EEA), butyl-acrylate (EBA) or vinyl acetate (EVA).

4. A composition according to claim 3, in which the butylene (co)polymer is polybutylene or polyisobutylene.

5. A composition according to claim 1, in which the ethylene (co)polymer is in the form of a metallocene catalyst ethylene (co)polymer.

6. A composition according to any claim 1, in which the ethylene (co)polymer or part thereof is grafted with compounds containing carboxylic acid or anhydride group(s).

7. A composition according to claim 6, in which the carboxylic acid or anhydride group is maleic anhydride or acid or fumaric anhydride or acid.

8. A composition according to claim 6, in which the grafted ethylene (co)polymer is a maleic anhydride (MAH) or maleic acid grafted copolymer.

9. A composition according to claim 8, in which the maleic anhydride (MAH) or maleic acid grafted copolymer is LDPE-MAH, LLDPE, HDPE-MAH, EP-MAH, EPR-MAH, PE-MAH or PP-MAH.

10. A composition according to claim 1, in which the ethylene (co)polymer contains polar group(s).

11. A composition according to claim 10, in which the polar group(s) are carboxylic group(s), maleic group(s) and/or ester group(s).

12. A composition according to claim 10, in which the amount of (co)polymer with polar group(s) is about 0.01% of the total (co)polymer.

13-14. (canceled)

15. A composition according to claim 10, in which the amount of (co)polymer with polar group(s) is at least about 8% of the total (co)polymer.

16. A composition according to claim 3, in which the ethylene content of the ethylene-propylene copolymer is about 10 to about 99.9% by weight.

17. (canceled)

18. A composition according to claim 3, in which the ethylene content of the ethylene-propylene copolymer is about 75 to about 99.9% by weight.

19. A composition according to claim 3, in which the vinyl acetate content of the ethylene-vinyl acetate copolymer (EVA) is about 3 to about 80% by weight.

20. (canceled)

21. A composition according to claim 1, in which the ethylene (co)polymer is a plastomer or an elastomer.

22. A composition according to claim 21, in which at least about 40% to about 50% by weight of the total weight of (co)polymer is a plastomer with the balance being an elastomer.

23. (canceled)

24. A composition according to claim 21, in which the plastomer is HDPE, MDPE, LDPE, LLDPE, VLDPE, EVA with up to about 30% vinyl acetate, EPM with up to about 25% propylene and/or an ethylene octene copolymer with S.G. of at least about 0.887.

25. A composition according to any claim 21, in which the elastomer is an ethylene octane copolymer with a S.G. of up to about 0.887, an ethylene hexene copolymer, ULDPE, ethylene propylene copolymer, an ethylene vinyl acetate copolymer with greater than about 38% vinyl acetate, EPDM, EPM, and/or EPR.

26. A composition according to claim 25, in which the ethylene propylene copolymer is a terpolymer with a propylene comonomer of greater than about 30%.

27. A composition according to claim 25, in which the vinyl acetate content for plastomeric EVA is about 9 to about 30% by weight.

28. A composition according to claim 25, in which the vinyl acetate content for elastomeric EVA is about 38 to about 50% by weight.

29. A composition according to claim 1, in which the cross-linkable and/or cross-linked ethylene (co)polymer forms at least about 40% by weight of the total weight of (co)polymer.

30. A composition according to claim 1, in which the nanofiller has particle(s) in the order of size of less than 50 nm.

31. A composition according to claim 1, in which the thickness of the nanofiller particles is about 1 nm to about 100 nm.

32. A composition according to claim 1, in which the diameter or length or width of the nanofiller is up to about 500 nm.

33. A composition according to claim 1, in which the layers of the nanofiller are composed of silicate.

34. A composition according to claim 1, in which the nanofiller is intercalated with an organic intercalatent.

35. A composition according to claim 34, in which the organic intercalatent is an ionic or polar compound(s).

36. A composition according to claim 35, in which the ionic or polar compound(s) is a quaternary ammonium salt.

37. A composition according to claim 36, in which the quaternary ammonium salt is an optionally substituted long chain hydrocarbon quaternary ammonium salt.

38. A composition according to claim 37, in which the optionally substituted long chain hydrocarbon quaternary ammonium salt is a benzyl or alkyl substituted long chain hydrocarbon quaternary ammonium salt, an alkyl substituted tallow or hydrogenated tallow quaternary ammonium salt and/or a bis-hydroxyethyl quaternary ammonium salt.

39. A composition according to claim 36, in which the counter anion for the quaternary ammonium cation is a halide or methyl sulphate.

40. A composition according to claim 1, in which the nanofiller is an intercalated mineral nanofiller or clay which is either synthetic or natural and has been intercalated by organic modification with ionic or polar substances.

41. A composition according to claim 40, in which the mineral or clay is montmorillonite, bentonite, smectite and/or phyllosilicate.

42. A composition according to claim 40, in which the nanofiller is Cloisite, Nanofil, Tixogel or Kunipia.

43. A composition according to claim 1, in which the amount of nanofiller is about 0.1 to about 15% by weigh.

44. (canceled)

45. A composition according to claim 43, in which the amount of nanofiller is about 2 to about 6% by weight.

46. A composition according to claim 35, in which the amount of organic intercalatent is up to about 40% by weight of the nanofiller.

47. A composition according to claim 1, further comprising a second filler.

48. A composition according to claim 47, in which the second filler is an inorganic and/or mineral filler.

49. A composition according to claim 47, in which the second filler is an optionally calcined clay, talc, mica, kaolin, alkaline earth metal carbonate, and/or metal hydroxide.

50. A composition according to claim 49, in which the alkaline earth metal carbonate is calcium carbonate, magnesium calcium carbonate and/or hydrated basic magnesium carbonate.

51. A composition according to claim 49, in which the metal hydroxide is aluminum and/or magnesium hydroxide.

52. A composition according to claim 47, in which the second filler is coated.

53. A composition according to claim 52, in which the second filler is coated with stearic acid, stearate, silane, siloxane and/or titanate.

54. A composition according to claim 1, further comprising an organic silane grafted to the ethylene (co)polymer and/or intercalated into the nanofiller.

55. A composition according to claim 54, in which the organic silane is a vinyl silane and/or a long aliphatic hydrocarbon chain silane.

56. A composition according to claim 55, in which the vinyl silane is a vinyl alkoxy silane.

57. A composition according to claim 56, in which the vinyl alkoxy silane is vinyl-tris-methoxy-silane (VTMOS), vinyl-tris-methoxy-ethoxy-silane(VTMEOS), vinyl-tris-ethoxy-silane, vinyl-methyl-dimethoxy-silane and/or gama-methacryl-oxypropyl-tris-methoxy-silane.

58. A composition according to claim 55, in which the vinyl silane is added in an amount from about 0.5 to about 2% by weight.

59. (canceled)

60. A composition according to claim 58, in which the vinyl silane is added in an amount of about 1% to about 1.8% by weight.

61. A composition according to claim 54, in which the organic silane is grafted using a free radical initiator.

62. A composition according to claim 61, in which the free radical initiator is a peroxide.

63. A composition according to claim 62, in which the peroxide is dicumyl peroxide, di-tertiary-butyl peroxide, di-tertiary-butyl-cumyl peroxide and/or bis-tertiary-butyl-cumyl peroxide.

64. A composition according to claim 61, in which the free radical initiator is added in an amount of about 0.05 to about 0.3% by weight.

65. (canceled)

66. A composition according to claim 1, in which the composition and/or ethylene (co)polymer are silane cross-linked, cross-linked by adding a cross-linking catalyst or radiation cross-linked.

67. A composition according to claim 1, further comprising one or more polymer processing additives.

68. A composition according to claim 67, in which the additive is an antioxidant, metal deactivator, copper inhibitor, UV absorber, foaming or blowing agent which is either endothermic or exothermic, processing and/or thermal stabiliser, pigment, flame retardant, extender, plasticiser and/or softener.

69. A process for preparing a cross-linkable and/or cross-linked nanofiller composition which comprises either:
(a) mixing and delaminating and/or exfoliating in one step a cross-linkable and/or cross-linked ethylene (co)polymer and an intercalated nanofiller;
(b) mixing a cross-linkable ethylene (co)polymer with an intercalated nanofiller; and
delaminating and/or exfoliating at least part of the nanofiller; or
(c) delaminating and/or exfoliating at least part of an intercalated nanofiller; and
mixing the delaminated and/or exfoliated intercalated nanofiller with a cross linkable and/or cross-linked ethylene (co)polymer.

70. A process according to claim 69, in which the ethylene (co)polymer and/or nanofiller are subjected to grafting either before, during or after the mixing and/or exfoliating and/or delaminating step(s).

71. A process according to claim 70, in which the grafting involves treating the ethylene (co)polymer and/or nanofiller with an organic silane which is then grafted onto the (co)polymer and/or intercalated into the nanofiller.

72. A process according to claim 71, in which the organic silane is grafted using a free radical initiator.

73. A process according to any claim 69, further comprising the step of cross-linking the (co)polymer after step (a) or cross-linking the composition after step (b) or (c).

74. A process according to claim 73, in which the composition and/or ethylene (co)polymer is silane cross-linked, cross-linked by adding a peroxide cross-linking catalyst, silane cross-linked or radiation cross-linked.

75. A process according to claim 69, in which the (co)polymer is granulated, pelletised, powderised, cut and/or diced.

76. A process according to claim 69, in which the (co)polymer and the nanofiller are premixed or added simultaneously, sequentially and/or separately to a mixing apparatus.

77. A process according to claim 69, in which the nanofiller or composition are exfoliated and/or delaminated using high shear processing.

78. A process according to claim 69, in which a further exfoliation and/or delamination step is performed at any stage of the process.

79. A process according to claim 69, in which other fillers and/or additives are added simultaneously, sequentially and/or separately at any step of the process.

80. A process according to claim 79, in which the (co)polymer, nanofiller, other fillers and/or additives are dry or dried in a separate step prior to step (a).

81. An article which is wholly or partly composed of the nanofiller composition defined in claim 1.

82. An article according to claim 81, which is a profile, tube, pipe, film, sheet, tile, floor covering, container or packaging for food.

83. A process for preparing the article defined in claim 81, which comprises a step selected from the group consisting of either:
(a) forming or shaping the nanofiller composition defined in claim 1;
(b) combining at least one layer of the nanofiller composition defined in claim 1 with at least one other polymeric layer;
(c) cross-linking the nanofiller composition defined in claim 1; and
(d) heating and stretching the nanofiller composition defined in claim 1 and cooling the stretched composition.
